(19) United States
(12) Patent Application Publication
(10) Pub. No.: US 2025/0025916 A1
(43) Pub. Date: Jan. 23, 2025

(54) Soil Compaction Device and Phase-Adjustable Unbalance Exciter with Two Driven Shafts

(71) Applicant: Wacker Neuson Produktion GmbH & Co. KG, Reichertshofen (DE)

(72) Inventor: Ferdinand Rupp, Oberguenzburg (DE)

(21) Appl. No.: 18/773,728

(22) Filed: Jul. 16, 2024

(30) Foreign Application Priority Data
Jul. 17, 2023 (DE) 10 2023 118 809.7

(51) Int. Cl. B06B 1/16; E01C 19/38; E02D 3/074

(52) U.S. Cl. CPC B06B 1/166; B06B 1/167; E01C 19/38; E02D 3/074

(57) ABSTRACT

An unbalance exciter is specified with at least two unbalance shafts arranged parallel to one another. Each of the unbalance shafts comprises its own, separately controllable drive for generating a drive torque. A coupling device is provided for coupling the two unbalance shafts so that they can counter-rotate. The coupling device comprises a backlash device for enabling a specific backlash in the rotational positions of the two unbalance shafts relative to one another. Backlash between the two unbalance shafts with a predetermined angle of rotation can be enabled by the backlash device, wherein the angle of rotation is selected from a range between 45° and 315°.

### BACKGROUND OF THE INVENTION

### 1. Field of the Invention

The invention relates to an unbalance exciter with two parallel driven shafts as well as a soil compaction device, that uses the unbalance exciter.

### 2. Description of the Related Art

Such soil compaction devices are known and are commonly known as vibratory plates or plate compactors. They typically comprise an upper mass and a lower mass, which are usually connected with one another by means of a rubber pad serving as a vibration decoupling device.

In known vibratory plates, a drive in the form of an internal combustion engine is provided on the upper mass. In addition, a drawbar with a guide bracket can be attached to the upper mass, with which the operator controls the vibratory plate. An unbalance exciter is provided on the lower mass, which is used to generate vibrations that are introduced into the ground to be compacted via a ground contact plate which is also provided on the lower mass.

The power of the drive motor is transferred to the unbalance exciter on the unbalance mass with the aid of a belt drive, in particular with small and medium-sized vibratory plates. In addition, a centrifugal clutch can be flange-mounted to the internal combustion engine serving as the drive motor so that the unbalance exciter is still decoupled from the motor at low engine speeds.

The unbalance exciter itself often comprises two unbalance shafts arranged parallel to one another and counter-rotating, each of which unbalance shafts bears eccentrically arranged weights (unbalance masses) in order to achieve the desired vibrations when the unbalance shafts rotate.

By changing the phase position of the unbalance shafts in relation to one another, in particular by changing the angular position of the unbalance shafts and thus the respective unbalance masses in relation to one another, the direction of a resulting force vector can be changed. In this manner, a reversibility of the vibratory plate is possible, so that the vibratory plate can be moved forwards and backwards. It is also possible to achieve on-the-spot compaction.

Examples of unbalance exciters constructed in this manner can be found in DE 24 09 417 A and DE 30 43 719 A1 and its U.S. counterpart U.S. Pat. No. 4,389,137, the contents of which are incorporated by reference.

DE 10 2020 102 949 A1, the contents of which is incorporated by reference, also discloses an unbalance exciter in which an electric motor is provided on the lower mass to drive the unbalance exciter, wherein the electric motor is integrated into the unbalance exciter.

This unbalance exciter also enables a switching over of directions. One of the unbalance shafts is driven by an electric motor, whereas the second is driven in the counter direction by means of spur gearing, wherein one of the spur gears can be rotated by approximately 180° relative to its unbalance shaft. A spiral or alternatively helical groove is provided for this purpose. The relative adjustment takes place by means of a piston that is hydraulically actuated in the axial direction, and is rotationally decoupled, which piston holds a shift pin, which in turn engages in the helical groove. The hydraulic pressure required for the switchover process is generated, for example, in a master cylinder on the guide drawbar by means of a piston with gear rack, geared shaft, and switchover bracket. In the case of vibratory plates with hydraulic drive, it can also be provided by the on-board hydraulics.

Numerous, comparatively expensive components are required for the described phase adjustment of the unbalance exciter, which is necessary in particular for the switching of direction or alternatively reversibility of the vibratory plate. These include, for example: drawbar head with master cylinder, geared shaft, master piston with gear rack, seals, hydraulic hose, adjustment cylinder, adjustment piston, rotational decoupling, piston with shift pin as well as adjustment sleeves with helical groove. In addition, the hydraulics required for phase adjustment can be susceptible to contamination, for example, by chips.

### SUMMARY OF THE INVENTION

The invention is based on the task of providing an unbalance exciter with a simplified construction which nevertheless provides the same functions as a more complex unbalance exciter.

The task is solved according to the invention by an unbalance exciter including at least two unbalance shafts arranged parallel to one another. Each of the unbalance shafts comprises its own, separately controllable drive for generating a drive torque. A coupling device is provided for coupling the two unbalance shafts so that they can counter-rotate. The coupling device comprises a backlash device for enabling a specific backlash in the rotational positions of the two unbalance shafts relative to one another.

An unbalance exciter with at least two unbalance shafts arranged parallel to one another is specified, wherein each of the unbalance shafts comprises its own, separately controllable drive for generating a drive torque; wherein a coupling device is provided for coupling the two unbalance shafts so that they can counter-rotate; and wherein the coupling device comprises a backlash device for enabling a specific backlash in the rotational positions of the two unbalance shafts relative to one another.

Backlash between the two unbalance shafts with a predetermined angle of rotation can, for example, be enabled by the backlash device, wherein the angle of rotation is selected from a range between 45° and 315°. This will hereinafter be elucidated in detail and with further examples.

The unbalance shafts consist of a shaft section on which one or a plurality of unbalance masses are arranged. By way of example, an unbalance shaft can comprise an unbalance mass permanently mounted on it, which can consist of a plurality of partial unbalance masses. In this manner, it is also possible to distribute the (total) unbalance mass in the form of a plurality of partial unbalance masses over the length of the unbalance shaft. By way of example, the partial unbalance masses can respectively be attached to both end faces of the unbalance shaft. The unbalance shafts are rotatably mounted in a common exciter housing.

An example of such an unbalance shaft is shown, for example, in DE 10 2020 102 949 A1. In the same document, it is also shown that the unbalance shaft can be driven by an electric motor integrated directly into the unbalance shaft. Whereas, however, in DE 10 2020 102 949 A1 only one of two unbalance shafts is driven by an electric motor, while the other, second unbalance shaft is entrained in a coupled manner by a coupling device, according to the invention both unbalance shafts are equipped with their own drive. The drive can also be integrated into the respective unbalance shaft in the form of an electric motor. It is likewise possible to provide the two drives separately from the unbalance shafts, wherein suitable torque transmission devices (for example, belt drive or hydraulic) must then be provided.

Each unbalance shaft thereby has its own separately controllable drive.

The coupling device allows a mechanically counter-rotating, for example, form-fitting counter-rotating coupling of the two unbalance shafts. “Coupling” in this context means that the rotation of the unbalance shafts is coupled together while maintaining the respective set phase position.

The strict, for example, form-fitting coupling is, however, offset or alternatively canceled out within a firmly defined framework by the backlash device. In this manner, the backlash device allows a targeted (rotational) backlash as regards the rotational positions of the unbalance shafts and thus as regards the phase position of the unbalance shafts in relation to one another. The unbalance shafts are freely rotatable relative to one another within the backlash, which is to say, within the specified angle of rotation range.

The targeted, predefined backlash of the rotational positions therefore allows for change in the phase position of the two unbalance shafts in relation to one another.

The targeted backlash of the rotational positions means, in particular, that two extreme rotational positions of the unbalance shafts relative to one another are enabled, which can be defined, for example, by two limit stops. Depending on the direction of rotation or alternatively the direction of flow of the drive torque between the two unbalance shafts, the unbalance shafts assume one or the other extreme position relative to one another and thus one or the other phase position relative to one another. In this manner, depending on the direction of flow of the drive torque, a predetermined phase position can be set by utilizing the backlash.

The backlash device provided as a component of the coupling device enables the definition of two limit positions or alternatively relative positions of the phase positions of the two unbalance shafts coupled by the coupling device. Depending on which limit position is assumed at the end of the backlash, the two unbalance shafts are in a predefined phase position relative to one another. In turn, the phase position determines the direction of a force vector arising (force vector resulting) from the rotating unbalance masses on the unbalance shafts. The rotational positions enabled by the backlash device can be selected so that the resulting force vector is suitable for either forward or backward travel.

The permissible extreme rotational positions are limited by a defined angle of rotation range, which is defined between 45° and 315°. The angle of rotation range thereby indicates the total angle range, which may optionally result from a plurality of, in particular, partial angles of rotation (in reference to two unbalanced shafts). The backlash enabled by the backlash device can thus be enabled in a (total) angle of rotation range between 0° and 720°, in particular between 90° and 720°, in particular between 90° and 270° as well as between 450° and 720°, in particular between 45° and 315°, in particular between 90° and 270°, in particular between 120° and 240°, in particular between 150° and 210°, in particular between 175° and 185°. An angle of rotation range that has proven itself in practice and is therefore preferred is ±90°, which is to say, in total (total angle of rotation range) approximately 180°.

A total angle of rotation range of 720° means that the phase position of both unbalance shafts can be rotated by 360° relative to the other unbalance shaft.

The backlash device can provide two rotational limit stops to define the limit positions of the angle of rotation of the unbalance shafts relative to one another enabled by the backlash. The two end stops or alternatively rotational limit stops thereby define two extreme positions into which the two unbalance shafts can be rotated relative to one another, corresponding to two defined different phase positions.

The two rotational limit stops can also be realized by a plurality of successively switched partial rotational limit stops, wherein the partial rotational limit stops enable respective partial angle of rotations, which, when summed, correspond to the total predetermined angle of rotation.

The two drives can be controlled in such a way that they, and thereby the unbalance shafts driven by them, are counter-rotatable, which is to say, with opposing directions of rotation.

The two drives can be controlled alternatingly in such a way that one of the drives generates a stronger drive torque than the other, wherein, depending on which drive is currently generating a stronger drive torque, one of the two limit positions of the two unbalance shafts defined by the respective rotational stop is set in relation to one another. The drive torque thereby flows from the stronger drive and the unbalance shaft driven by it via the coupling device to the more weakly driven unbalance shaft or alternatively the weaker drive.

Both drives can thereby be operated simultaneously, wherein one of the two drives generates a higher drive torque than the other in order to achieve a defined relative position of the two unbalance shafts to one another and thus a defined phase position. It is also possible for only one of the drives to be driven while the other drive is not operated or braked and therefore does not generate any drive torque. This non-driven or alternatively braked drive is then entrained by the driven drive, together with the unbalance shaft assigned to it. The braking of the drive can, for example, also occur in a targeted manner, for example, by operating this drive in a generating manner, which is to say as a generator.

In the case of a change of the drive with the stronger drive torque and an associated change in the direction of flow of the drive torque, the rotation of the two unbalanced shafts enabled by the backlash device can be triggered automatically and the other phase position can therefore be set. The setting of the phase position therefore occurs depending on the direction of rotation of the drives or alternatively the direction of flow of the drive torques of the two drives. This also applies if one of the two drives is not driving or braked so that it does not generate any drive torque.

An operating state in which one of the drives is activated while the other drive is not activated or is activated with limited power is therefore possible. The activated drive, in particular the drive activated with full drive power, should then entrain or alternatively pull along the non-activated or alternatively weaker drive.

Each of the unbalance shafts can comprise a separately controllable electric motor as a drive. The electric motor can comprise a rotor, which can be a component of the associated unbalance shaft. The rotor can then, in particular, be formed directly on the unbalance shaft, whereas an associated stator can be accommodated in the exciter housing.

A “forward travel” operating state can be provided, wherein one of the unbalance shafts is a first unbalance shaft and the other unbalance shaft is a second unbalance shaft, wherein the first unbalance shaft is driven by the drive assigned to it and the second unbalance shaft is not driven or is driven more weakly than the first unbalance shaft by the drive assigned to it, and wherein, when the first unbalance shaft is driven, the backlash in the backlash device is overcome and the second unbalance shaft is entrained by the coupling device. Overcoming the backlash is understood to mean that respectively one of the rotational limit stops comes into effect and thereby the two unbalance shafts assume a defined phase position in relation to one another.

As an alternative to the “forward travel” operating state, a “backward travel” operating state can be provided, in which the second unbalance shaft is driven by the drive assigned to it and the first unbalance shaft is not driven or is driven more weakly than the second unbalance shaft by the drive assigned to it, and in which, when the second unbalance shaft is driven, the backlash in the backlash device is overcome and the first unbalance shaft is entrained by the coupling device.

An “on-the-spot compaction” operating state can, moreover, be provided by a repeated switching over between the “forward travel” operating state and the “backward travel” operating state, wherein the time periods in which the “forward travel” operating state and the “backward travel” operating state are respectively activated are identical, but each shorter than 5 seconds. The “on-the-spot compaction” operating state enables localized compaction by a vibratory plate equipped with the unbalance exciter, which is to say, compaction on the spot without the vibratory plate moving forwards or backwards.

The “on-the-spot compaction” operating state is achieved by a quick switch over between forward travel and backward travel, namely before the vibratory plate can move in the corresponding direction. Inasmuch as the vibratory plate comprises a large inertial mass, it generally requires a certain amount of time to start moving, even if the resulting force vector is already aligned in one direction. Before the vibratory plate can thereby undertake travel, the direction of travel in the unbalance exciter is switched over by switching the operating state from forward travel to backward travel and vice versa, so that as a result, the vibratory plate persists on-the-spot. The time period for switching between forward travel and backward travel should preferably be selected so that the respective rotational stop reaches its defined limit position.

The specified maximum period of 5 seconds may be too long, depending on the embodiment. Accordingly, the time period can also be less than 4 seconds, less than 3 seconds, less than 2 seconds or less than 1 second. By way of example, the two drives of the unbalance shafts can be driven alternatingly every 2 seconds in order to affect the changeover between forward and backward travel and thus achieve an on-the-spot compaction.

In addition or alternatively, a “slow travel” operating state can be provided, in which a repeated switching between the “forward travel” and “backward travel” operating states takes place, wherein the time periods in which the “forward travel” and “backward travel” operating states are activated vary depending on the desired direction of travel, but are each shorter than 8 seconds, for example, shorter than 5 seconds or shorter than 3 seconds. In this operating state, the “on-the-spot compaction” operating state described above is thus varied. Here too, there is regular, relatively rapid switching over between forward travel and backward travel. However, whereas the respective time periods for forward travel and backward travel are identical for on-the-spot compaction, the time periods for the “slow travel” operating state are different. By way of example, for slow forward travel, the time period for forward travel is specified to be slightly longer than for backward travel. In this manner it is achieved that the resulting force vector for the forward travel is slightly longer than that for the backward travel, so that as a result-due to the high inertia of the vibratory plate-a slower forward travel is achieved.

By way of example, a time period of 3 seconds in the forward direction and 2 seconds in the backward direction can be set for slow forward travel.

The above definitions “first unbalance shaft” and “second unbalance shaft” are arbitrary. By way of example, the unbalance shaft that is driven in the case of the “forward travel” operating state could always be defined as the “first unbalance shaft”. The second unbalance shaft would then be the other unbalance shaft or alternatively the unbalance shaft that is driven in the “backward travel” operating state.

Both unbalance shafts can respectively bear a gear wheel, wherein the gear wheels are arranged to intermesh with one another, and wherein one or both of the gear wheels can be rotated relative to the unbalance shaft bearing them over an angular range defined by rotational limit stops. The gear wheels can thereby be part of the coupling device and transmit the drive torque from one unbalance shaft to the other. Due to the relative rotatability of the two gear wheels (or of only one gear wheel) relative to the associated unbalance shaft, it is possible to set the different phase positions. Accordingly, rotational limit stops are provided which define the relative rotation of the gear wheels (or the gear wheel).

The backlash device can comprise two rotational limit stops on one of the unbalance shafts, which are rotated relative to one another by an angle corresponding to the predefined angle of rotation range. The two rotational limit stops then form the end stops for the two predefined phase positions of the unbalance shafts. By way of example, the rotational limit stops can be rotated by an angle of approximately 180° to one another.

In one variant, the backlash device can respectively comprise two rotational limit stops on both unbalance shafts, which are respectively rotated by a partial angle of rotation relative to the other, wherein the sum of the partial angle of rotations corresponds to the specified angle of rotation range. In this case, the limit stops are distributed over both unbalance shafts. By way of example, both gear wheels of the coupling device can rotate relative to the unbalance shaft supporting them.

The coupling device may comprise two gear wheels intermeshing with one another, which are respectively arranged on one of the unbalance shafts, wherein one of the gear wheels is a first gear wheel which is fixedly arranged on the first unbalance shaft, wherein the other of the gear wheels is a second gear wheel which is arranged on the second unbalance shaft so as to be rotatable relative to it, wherein the backlash device comprises a driver which is inserted into the second unbalance shaft, wherein the two rotational limit stops are provided on the second gear wheel and wherein the driver strikes against one of the rotational limit stops depending on the direction of flow of the drive torque between the two gear wheels.

In this variant, one of the gear wheels is therefore fixedly arranged on the (first) unbalance shaft, whereas the gear wheel on the second unbalance shaft is rotatable within the angle of rotation range.

The driver can, for example, be formed by a pin.

In one variant, the coupling device can comprise two gear wheels intermeshing with one another, which are respectively arranged on one of the unbalance shafts, wherein both gear wheels are rotatably arranged relative to the unbalance shaft bearing them, wherein in both of the unbalance shafts a driver is respectively inserted, wherein two rotational limit stops are respectively provided on both gear wheels, wherein the two drivers strike against one of the rotational limit stops assigned to them depending on the direction of flow of the drive torque between the two gear wheels. Here too, the drivers can, for example, be configured as pins or bolts.

In this alternative variant, both gear wheels are rotatable relative to the unbalance shaft assigned to them, in particular rotatable about a partial angle of rotation, so that the sum of the partial angle of rotations (for example, respectively) 90° results in the total specified angle of rotation (for example,) 180°.

In the case of this last variant, it is possible that both unbalance shafts and both drives are constructed identically. This can also apply to the coupling device and the backlash device, which is to say, also for the gear wheels, the rotational limit stops and the drivers (for example, pins). In this manner, many identical parts can be used. The complete unbalance shafts can be completely identical and incorporated in the exciter housing.

The described unbalance exciter can be used particularly advantageously with a soil compaction device, such as a vibratory plate or plate compactor. Accordingly, a soil compaction device is also provided, with an upper mass, with a lower mass that is movable relative to the upper mass, with a ground contact plate for concrete compaction, with a vibration decoupling device acting between the upper mass and the lower mass, and with at least one unbalance exciter belonging to the lower mass for applying an unbalance force to the ground contact plate, wherein the unbalance exciter is an unbalance exciter of the type described above.

### BRIEF DESCRIPTION OF THE DRAWINGS

These and further advantages and features are elucidated in more detail below on the basis of examples with the aid of the accompanying figures. Wherein:

FIG. 1 shows a soil compaction device according to the invention in side view;

FIG. 2 shows an unbalance exciter in cross-sectioned plan view and perspective partial view;

FIG. 3 shows a variant to the unbalance exciter of FIG. 2;

FIG. 4 shows an example for the position of the coupling device and backlash device in the “forward travel” operating state;

FIG. 5 shows an example for the position of the coupling device and the backlash device in the “backward travel” operating state at the time of switchover;

FIG. 6 shows the operating state of FIG. 5, however at a point in time after the unbalance shafts have completed a rotation of 90°;

FIG. 7 shows a variant of FIG. 4, with an example for the position of the coupling device and backlash device in the “forward travel” operating state;

FIG. 8 in variant of FIG. 7, shows an example for the position of the coupling device and the backlash device in the “backward travel” operating state at the time of the switchover; and

FIG. 9 shows the operating state of FIG. 8, however at a point in time after the unbalance shafts have completed a rotation of 270°.

### DETAILED DESCRIPTION

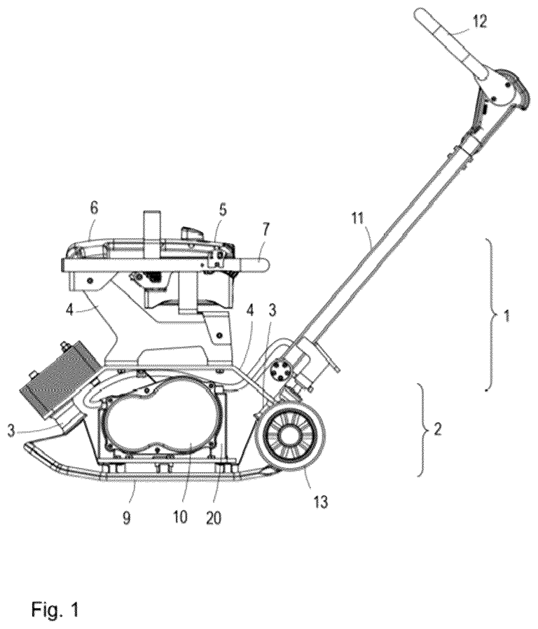

FIG. 1 shows an example for a vibratory plate serving as a soil compaction device.

The vibratory plate comprises an upper mass 1 and a lower mass 2 that is movable relative to the upper mass 1. The lower mass 2 is coupled to the upper mass 1 by means of rubber pad 3, which serves as a vibration decoupling device. In this manner, the strong vibrations generated at the lower mass 2 are only transmitted to the upper mass 1 in a damped manner.

The upper mass 1 comprises a support frame 4 on which a rechargeable battery 5 and a transformer 6 are mounted, which are also assigned to the upper mass 1. The rechargeable battery 5 and the transformer 6 are enclosed by a protection frame 7.

The rechargeable battery 5 is replaceable and can be replaced by another rechargeable battery if necessary. For this purpose, a plug connector is provided on the transformer 6 or alternatively on the transformer housing belonging to the transformer 6, to which the rechargeable battery 5 can be plugged in.

The lower mass 2 comprises a ground contact plate 9, which can be used to compact the ground found underneath it. A vibration exciter or alternatively unbalance exciter 10, which also belongs to the lower mass 2, is arranged on the top of the ground contact plate 9.

In the state of the art, such unbalance exciters are generally rotationally driven by engines, in particular internal combustion engines, which are arranged on the upper mass. According to the invention, there are, however, two electric motors, not shown in FIG. 1, that are integrated in the unbalance exciter 10, which will be elucidated hereinafter.

To guide the vibratory plate, a guide drawbar 11 is also attached to the upper mass 1 or alternatively to the support frame 4. A speed lever, not shown, can be provided on the guide drawbar 11 for influencing the motor speeds of the electric motors serving as drive motors. Depending on the embodiment, an on/off switch may however also be sufficient to switch on the electric motors, which will be elucidated hereinafter.

A guide bracket or alternatively drive handle 12 is arranged at the upper end of the guide drawbar 11, by means of which the relative rotational position of the unbalance shafts in the unbalance exciter 10, in particular their phase position relative to one another, can be adjusted, as will be elucidated hereinafter. In this manner, a forward and backward travel of the vibratory plate can be achieved in a manner known per se.

A wheeled device with two axially aligned wheels 13 is provided on the lower mass 2 or alternatively on the ground contact plate 9. In the normal state shown in FIG. 1, the wheels 13 float above the ground. By tilting the vibratory plate, it is however possible to bring the wheels 13 into contact with the ground so that the ground contact plate 9 lifts completely off the ground. In this tilted or alternatively transport state, the vibratory plate can be easily moved and transported using the wheels 13.

The unbalance exciter 10 comprises an exciter housing 20 which, as FIG. 1 shows, is attached directly to the ground contact plate 9 in order to be able to optimally introduce the vibrations generated by the unbalance exciter 10 into the ground contact plate 9 and thereby the ground to be compacted.

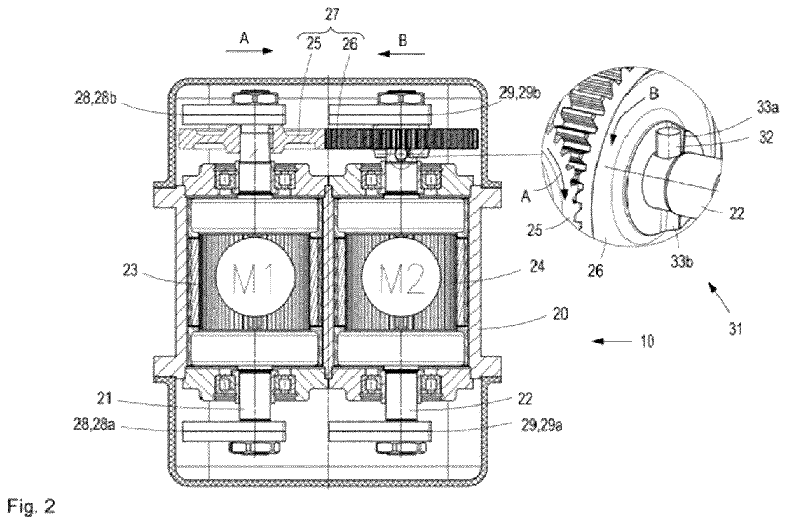

FIG. 2 shows a cross-sectioned plan view of the unbalance exciter 10.

Two unbalance shafts are rotatably mounted inside the exciter housing 20, namely a first unbalance shaft 21 and a second unbalance shaft 22. The first unbalance shaft 21 can be driven by a first electric motor 23 (M1), the second unbalance shaft 22 by a second electric motor 24 (M2).

The two unbalance shafts 21, 22 are counter-rotatably coupled to one another. For this purpose, a gear wheel pairing is provided, with a first gear wheel 25 mounted on the first unbalance shaft 21 and a second gear wheel 26 mounted on the second unbalance shaft 22. The two gear wheels 25, 26 together form part of a coupling device 27 and intermesh with one another, as FIG. 2 also shows in perspective view in the right-hand part of the image. In this manner, depending on which of the two unbalance shafts 21, 22 is driven, a rotation of one unbalance shaft is transmitted directly into a counter-rotation of the other unbalance shaft.

The first unbalance shaft 21 bears a first unbalance mass 28, which is subdivided into two partial mass elements 28a, 28b. The two partial mass elements 28a, 28b are axially spaced out from one another and arranged on the end-face side ends of the first unbalance shaft 21. The second unbalance shaft 22 on its side bears a second unbalance mass 29, which is formed by the partial mass elements 29a, 29b.

Both unbalance shafts 21, 22 are mounted on roller bearings. Unbalance masses 28, 29 are located on all four shaft ends. The gear wheels 25, 26 are arranged between the roller bearings and the respective unbalance masses 28, 29. The mechanical coupling of the two unbalance shafts 21, 22 is subject to a considerable backlash, so that when one shaft is held, the other can be rotated by approximately ±90°, as will be elucidated hereinafter.

The two electric motors 23, 24 are respectively arranged in the middle area of both of the two unbalance shafts 21, 22. Both electric motors 23, 24 can be controlled individually and can act alternatingly as drive motors. By way of example, it is possible to activate only one of the electric motors 23, 24 while the other electric motor 23, 24 is entrained. It is likewise possible to operate both electric motors 23, 24, wherein-as will be elucidated hereinafter-depending on the desired phase position, one of the electric motors 23, 24 should provide a lesser drive torque than the other. The direction of rotation of the two electric motors 23, 24 run counter to one another, as indicated by the arrows A (for the first unbalance shaft 21 or alternatively the first electric motor 23) and B (for the second unbalance shaft 22 or alternatively the second electric motor 24).

The electric motors 23, 24 can be integrated into the unbalance shafts 21, 22 that bears them. It is, in particular, possible that the electric motors 23, 24 respectively comprise one rotor, that is directly mounted on the corresponding unbalance shaft 21, 22. For this reason, a corresponding rotor seat is provided on the respective unbalance shaft 21, 22. Accordingly, the respective unbalance shaft 21, 22 also functions as a motor shaft of the electric motor 23, 24.

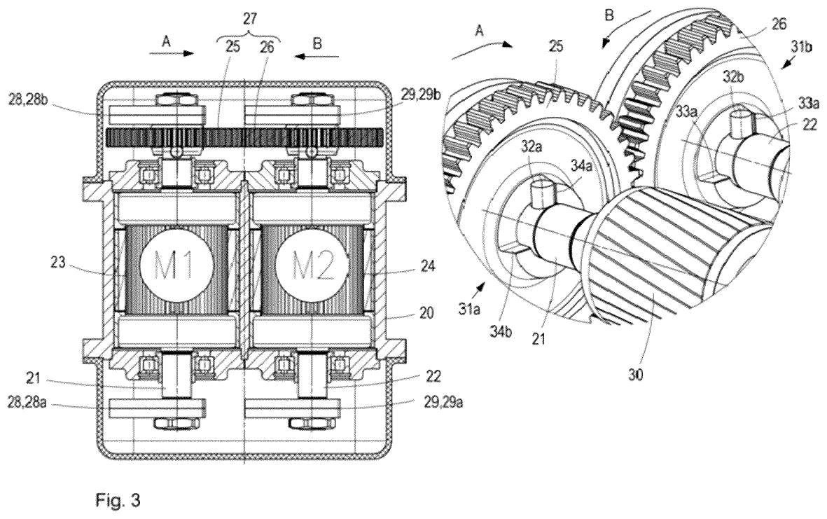

An example of a rotor is indicated with the reference sign 30 in the hereinafter elucidated FIG. 3.

The rotors are respectively enclosed by a stator, which stator also belongs to the respective electric motor 23, 24 and is suitably mounted in the exciter housing 20. The electric motors 23, 24 can, however, also be inserted into the exciter housing 20 as complete units. The exciter housing 20 thereby supports both stators of the electric motors 23, 24 as well as the roller bearings of the unbalance shaft 21, 22. It is therefore advantageous if the electric motors 23, 24 are fully integrated into the unbalance exciter 10. It is therefore not necessary to drive the unbalance exciter 10 from the outside, as is widely known from the prior art. The unbalance exciter 10 forms an integral unit with the two integrated electric motors 23, 24 and requires no further external drive.

The two electric motors 23, 24 are only shown by way of example. Solutions are also possible in which the electric motors are provided outside the exciter housing 20. Hydraulic motors can likewise be used. The motors can be mounted on the outside of the exciter and mounted outside the unbalances.

The first gear wheel 25 is fixed to the first unbalance shaft 21 so that it cannot rotate, for example, with the aid of a suitable shaft-to-hub connection, such as a parallel key or a clamping seat.

A backlash device 31 is shown in the perspective enlargement shown in the right-hand section of FIG. 2.

The second gear wheel 26, which intermeshes with the first gear wheel 25 and can therefore counter-rotate, is held on the second unbalance shaft 22. The backlash device 31 is provided, which allows a defined backlash in the form of a relative rotatability of the second gear wheel 26 relative to the second unbalance shaft 22 that bears the gear wheel 26. The backlash device 31 comprises a bolt or pin 32 which is received vertically in the second unbalance shaft and serves as a driver, which driver can optionally strike against limit stops 33a and 33b. The second gear wheel 26 is thereby rotatably mounted on the second unbalance shaft 22, wherein the rotatability is limited by the interaction of the pin 32 and the two limit stops 33a, 33b.

The pin 32, together with the unbalance mass 29 arranged behind it, also acts as an axial locking device for the rotatable second gear wheel 26 arranged between them.

In the example shown, the two limit stops 33a, 33b are configured in such a way that the second gear wheel 26 can be rotated through a 180° angle relative to the second unbalance shaft 22, depending on the direction of action of the driving torque.

With reference to the arrangement shown in FIG. 2 with the directions of rotation A and B, and assuming that only the first electric motor 23 is driving, whereas the second electric motor 24 is switched off, the first gear wheel 25 drives in arrow direction A, the second gear wheel 26 drives in arrow direction B. Since the second electric motor 24 is switched off, it generates a frictional or alternatively drag torque and brakes. Accordingly, the second gear wheel 26 also drives the second unbalance shaft 22 in direction of rotation B by means of the limit stop 33a and the pin 32.

In a reverse situation, which is not shown in FIG. 2, the second electric motor 24 drives alone whereas the first electric motor 23 is switched off. In this case, the second unbalance shaft 22 rotates drivingly in arrow direction B, so that making use of the backlash the pin 32 rotates downwards by 180°, until it strikes against the limit stop 33b. The pin 32 then also drives the second gear wheel 26 in direction of rotation B, whereupon the first gear wheel 25, together with the first unbalance shaft 21, rotates in arrow direction A.

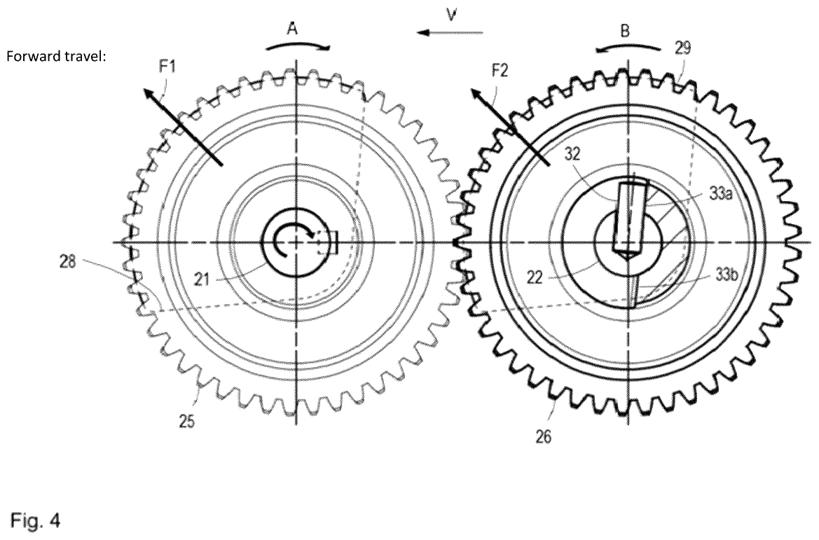

The unbalance masses 29 borne by the second unbalance shaft 22 are placed in a different relative position and thus phase position to the unbalance masses 28 of the first unbalance shaft 21 due to the backlash-induced free, which is to say, uncoupled, pivoting of the second unbalance shaft 22 through a 180° angle relative to the first unbalance shaft 21, which first unbalance shaft is still stationary during the pivoting process. This results in a change in the direction of action of the resulting force, as will be elucidated hereinafter with reference to FIG. 4 through FIG. 6.

The backlash device 31 with the pin 32 and the limit stops 33a, 33b is merely an example. Other solutions are also conceivable for the realization of the backlash device 31, for example, landings and limit stop surfaces that are arranged directly on the respective unbalance shaft.

FIG. 3 shows a variant of the unbalance exciter of FIG. 2. Reference is made to the reference signs of FIG. 2.

In contrast to the embodiment of FIG. 2, in the variant of FIG. 3 both gear wheels 25, 26 are pivotable over a defined angular range-namely 90° in each case-relative to the respective unbalance shaft 21, 22 supporting them.

Whereas in the variant of FIG. 2, the backlash device 31 was merely arranged on one of the unbalance shafts (in the example shown on the second unbalance shaft 22) and permitted backlash over the entire defined angle of rotation, in the variant of FIG. 3, the backlash device 31 extends to both unbalance shafts 21, 22, as can be seen in the enlarged perspective view in the right-hand part of FIG. 3. In particular, a first backlash device 31a is present on the first unbalance shaft 21 and a second backlash device 31b on the second unbalance shaft 22, with a pin 32a and 32b. In addition, similarly to the variant shown in FIG. 2, limit stops 33a and 33b are provided on the second unbalance shaft 22 and limit stops 34a, 34b on the first unbalance shaft 21.

Whereas the limit stop surfaces 33a, 33b in the variant of FIG. 2 are offset by an angle that permits an angle of rotation of the second gear wheel 26 relative to the unbalance shaft 22 of 180°, the limit stop surfaces 33a, 33b, 34a, 34b in the variant of FIG. 3 are configured in such a way that a relative rotation of the two gear wheels 25, 26 relative to the unbalance shafts 21, 22 supporting them is possible with a respective angle of rotation of 90°. In total, however, similarly to FIG. 2, this in turn results in a total angle of rotation of 180°.

With reference to the force vector resulting from the rotation of the unbalance shafts 21, 22, the variants of FIG. 2 and FIG. 3 do not differ. In the variant of FIG. 3, however, it is possible to implement both unbalance shafts 21, 22, including the other components used, as identical parts, which further reduces the number of components to be used.

If the first unbalance shaft 21 is rotationally driven in arrow direction A by the first electric motor 23 provided there, while the second electric motor 24 on the second unbalance shaft 22 is either not operated or is only operated to a lesser extent, the pin 32a impinges against the limit stop surface of the limit stop 34a, whereby the gear wheel 25 is rotated in arrow direction A and the second gear wheel 26 is rotated in arrow direction B. The second gear wheel 26 takes the pin 32b with it by means of its limit stop 33a and thus entrains the second unbalance shaft 22 with the second electric motor 24.

FIG. 4 shows a schematic representation of a view on the two gear wheels 25, 26 as well as the unbalance masses 28, 29, which are located behind them and are only shown as dashed lines.

The phase position for forward travel in the forward travel direction V, as illustrated by the arrow is represented. The first unbalance shaft 21 is driven in direction of rotation A. A force vector F1 is generated by the effect of the rotating unbalance mass 28.

The situation already elucidated above with reference to FIG. 2 is represented. Accordingly, the second gear wheel 26 with the second unbalance mass 29 is rotated in arrow direction B. The centrifugal force F2 is generated by the rotational effect. The two centrifugal forces F1, F2 are superimposed and form a resultant force in the same direction, which is not shown in FIG. 4. The resulting force comprises oscillating components in the vertical direction, which are used for ground compaction, as well as a component in the horizontal direction, which in this case is directed in the direction of travel V. In this manner, the vibratory plate using the unbalance exciter can be moved in the forward direction V.

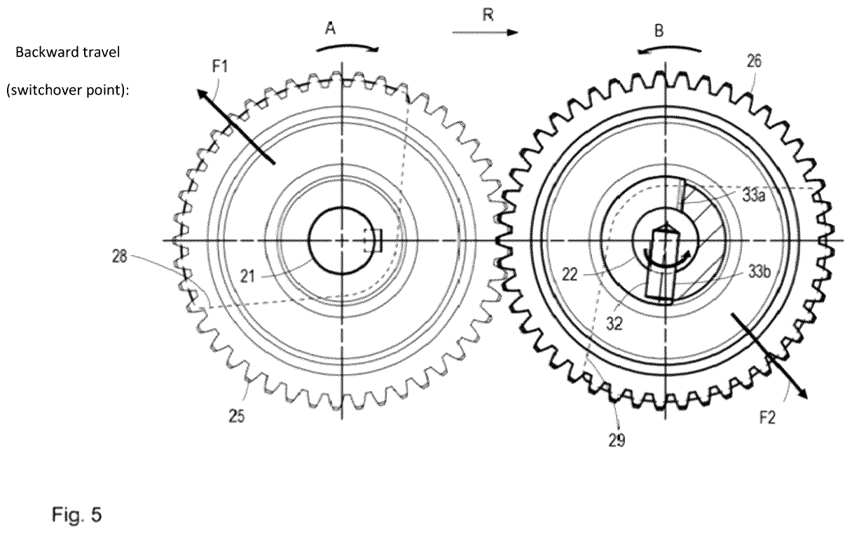

FIG. 5 shows the moment of switching over from forward travel to backward travel, starting from the situation in FIG. 4. In order to reach the switchover point, the first electric motor 23 is switched off so that the first unbalance shaft 21 is no longer driven. Instead, the second electric motor 24 is activated and the second unbalance shaft 22 is driven in arrow direction B. As a result, the pin 32 rotates by 180°—corresponding to the arrangement of the limit stops 33a, 33b—and thereby reaches the position shown in FIG. 5. In this situation, the pin 32 contacts the limit stop 33b and begins to rotate the second gear wheel 26 in arrow direction B. The second unbalance mass 29 coupled thereto generates an unbalance force F2 that is directed in the backward travel direction R.

In this situation, the first unbalance shaft 21 is still unchanged and, when compared to the situation in FIG. 4, has not moved, in particular not rotated. This only occurs upon further rotation of the now driving second unbalance shaft 22.

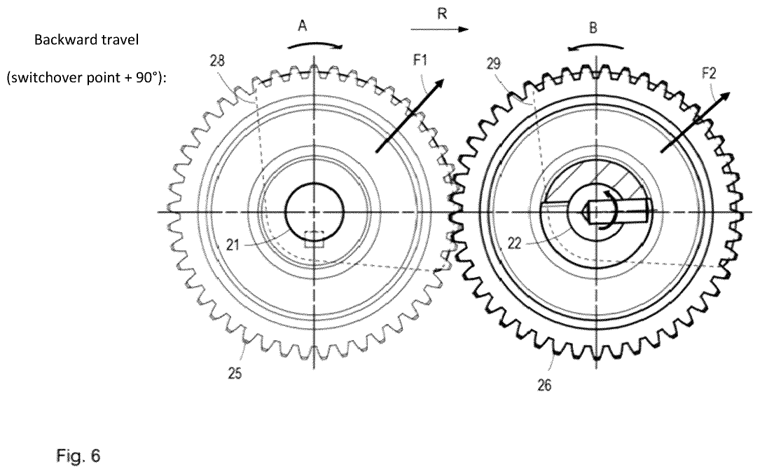

FIG. 6 shows a situation in which, starting from the situation in FIG. 5, the two unbalance shafts 21, 22 and thereby also the gear wheels 25, 26 and the unbalance masses 28, 29 have rotated by a 90° angle in their respective directions of rotation A, B. It can be seen here that the force vectors F1, F2 are directed in the backward direction R, so that backward travel can be achieved. To continue the backward travel, the second electric motor 24 and thereby the second unbalance shaft 22 is rotated further in the direction of rotation B, whereas the first unbalance shaft 21 with the first electric motor 23 is entrained in the direction of rotation A.

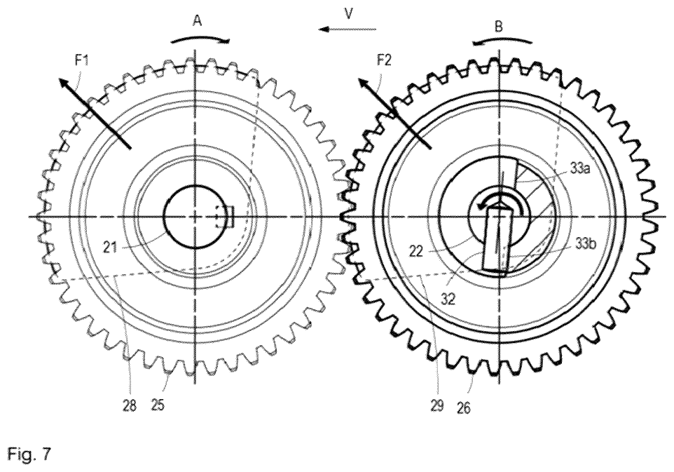

FIG. 7 through FIG. 9 show a variant of the unbalance exciter of FIG. 4 through FIG. 6. Whereas in the variant of FIG. 4 through FIG. 6 the full centrifugal force of the exciter or alternatively of a plate compactor supporting it does not act in the case of an on-the-spot compaction, in the unbalance exciter of FIG. 7 through FIG. 9, a strong oscillating vertical force can additionally be generated in the operating state of the on-the-spot compaction.

The construction of the two variants is thereby substantially identical.

In contrast to FIG. 4, as a comparison of the two figures shows, in FIG. 7, which also shows the “forward travel” operating state, the second unbalance shaft 22 is however driven and the second unbalance mass 29 is structurally rotated by 180° relative to the unbalance shaft 22. The first unbalance shaft 21 is entrained in this state. The two centrifugal forces F1 and F2 are identical to the variant of FIG. 4.

The definition “first unbalance shaft” and “second unbalance shaft” is arbitrary and in the example shown was chosen in order to be able to compare the two variants more easily. By way of example, the unbalance shaft that is driven in the “forward travel” operating state could easily be defined as the “first unbalance shaft”. The second unbalance shaft would then be the other unbalance shaft or alternatively the unbalance shaft that is driven in the “backward travel” operating state.

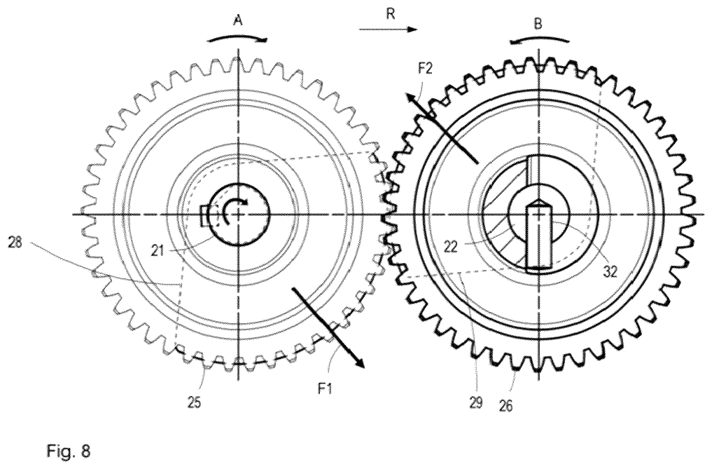

FIG. 8 shows the moment of the switchover from forward travel to backward travel, starting from the situation in FIG. 7 and therefore similar to FIG. 5. The second electric motor 24 is now switched off so that the second unbalance shaft 22 is no longer driven. Instead, the first electric motor 23 is activated and the first unbalance shaft 21 is driven in arrow direction A. As a result, the pin 32 rotates on the second unbalance shaft 22 relative to the limit stops 33a, 33b.

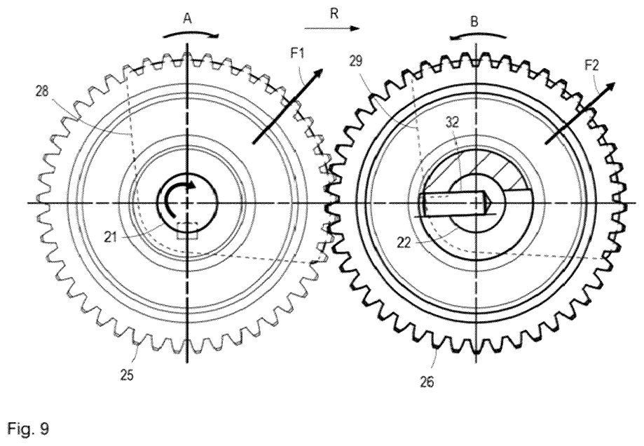

FIG. 9 shows a situation in which, starting from the situation in FIG. 8, the two unbalance shafts 21, 22 and thereby also the gear wheels 25, 26 and the unbalance masses 28, 29, have rotated by a 270° angle in their respective directions of rotation A, B. It can be seen here that the force vectors F1, F2 are directed in the backward direction R so that backward travel can be achieved. To continue the backward travel, the first electric motor 23 and thereby the first unbalance shaft 21 is rotated further in the direction of rotation A, whereas the second unbalance shaft 22 with the second electric motor 24 is entrained in the direction of rotation B.

1. An unbalance exciter comprising:
at least two unbalance shafts arranged parallel to one another; wherein
each of the unbalance shafts comprises its own, separately controllable drive for generating a drive torque;
a coupling device is provided for coupling the two unbalance shafts so that they can counter-rotate; and wherein
the coupling device comprises a backlash device for enabling a specific backlash in the rotational positions of the two unbalance shafts relative to one another.

2. The unbalance exciter according to claim 1, wherein the backlash device provides at least two rotational limit stops to define limit positions of the angle of rotation enabled by the backlash.

3. The unbalance exciter according to claim 2, wherein
the drives can be controlled alternatingly in such a way that one of the drives generates a stronger drive torque than the other drive; and wherein
depending on which drive is currently generating a stronger drive torque, one of the two limit positions of the two unbalance shafts defined by the respective rotational stop is set in relation to one another.

4. The unbalance exciter according to claim 1, wherein a “forward travel” operating state is provided, wherein
one of the unbalance shafts is a first unbalance shaft and the other unbalance shaft is a second unbalance shaft;
the first unbalance shaft is driven by the drive assigned to it and the second unbalance shaft is not driven or is driven more weakly than the first unbalance shaft by the drive assigned to it; and wherein
when the first unbalance shaft is driven, the backlash in the backlash device is overcome and the second unbalance shaft is entrained by the coupling device.

5. The unbalance exciter according to claim 4, wherein a “backward travel” operating state is provided, wherein
the second unbalance shaft is driven by the drive assigned to it and the first unbalance shaft is not driven or is driven more weakly than the second unbalance shaft by the drive assigned to it, and wherein
when the second unbalance shaft is driven, the backlash in the backlash device is overcome and the first unbalance shaft is entrained by the coupling device.

6. The unbalance exciter according to claim 5, wherein
an “on-the-spot compaction” operating state is provided by a repeated switching over between the “forward travel” operating state and the “backward travel” operating state;
the time periods in which the “forward travel” operating state and the “backward travel” operating state are respectively activated are identical, but each shorter than 5 seconds.

7. The unbalance exciter according to claim 5, wherein
a “slow travel” operating state can be provided, in which a repeated switching between the “forward travel” and “backward travel” operating states takes place; and wherein
the time periods in which the “forward travel” and “backward travel” operating states are activated vary depending on the desired direction of travel, but are each shorter than 8 seconds.

8. The unbalance exciter according to claim 1, wherein
both unbalance shafts respectively bear a gear wheel;
the gear wheels are arranged to intermesh with one another, and wherein
one or both of the gear wheels is rotatable relative to the unbalance shaft bearing them over an angular range defined by rotational limit stops.

9. The unbalance exciter according to claim 1, wherein the backlash device comprises two rotational limit stops on one of the unbalance shafts, which are rotated relative to one another by an angle corresponding to the predefined angle of rotation range.

10. The unbalance exciter according to claim 1, wherein
the backlash device comprises two rotational limit stops on both unbalance shafts, which are respectively rotated by a partial angle of rotation relative to the other; and wherein
the sum of the partial angle of rotations corresponds to the specified angle of rotation range.

11. The unbalance exciter according to claim 1, wherein
the coupling device comprises two gear wheels intermeshing with one another, which are respectively arranged on one of the unbalance shafts;
one of the gear wheels is a first gear wheel which is fixedly arranged on the first unbalance shaft;
the other of the gear wheels is a second gear wheel which is arranged on the second unbalance shaft so as to be rotatable relative to it;
the backlash device comprises a driver which is inserted into the second unbalance shaft;
both rotational limit stops are provided on the second gear wheel; and wherein
the driver strikes against one of the rotational limit stops depending on the direction of flow of the drive torque between the two gear wheels.

12. The unbalance exciter according to claim 1, wherein
the coupling device comprises two gear wheels intermeshing with one another, which are respectively arranged on one of the unbalance shafts;
both gear wheels are rotatably arranged relative to the unbalance shaft bearing them;
a driver is inserted in each of the unbalance shafts;
two rotational limit stops are respectively provided on both gear wheels; and wherein
the two drivers strike against one of the rotational limit stops assigned to them depending on the direction of flow of the drive torque between the two gear wheels.

13. The unbalance exciter according to claim 1, wherein both unbalance shafts and both drives are constructed identically.

14. Soil compaction device, comprising:
an upper mass;
a lower mass that is movable relative to the upper mass, the lower mass including a ground contact plate for compaction;
a vibration decoupling device acting between the upper mass and the lower mass; and
at least one unbalance exciter, belonging to the lower mass, for applying an unbalance force to the ground contact plate; wherein
the unbalance exciter is an unbalance exciter including
at least two unbalance shafts arranged parallel to one another; wherein
each of the unbalance shafts comprises its own, separately controllable drive for generating a drive torque;
a coupling device is provided for coupling the two unbalance shafts so that they can counter-rotate; and wherein
the coupling device comprises a backlash device for enabling a specific backlash in the rotational positions of the two unbalance shafts relative to one another.
